(19) United States
(12) Patent Application Publication
(10) Pub. No.: US 2011/0316336 A1
(43) Pub. Date: Dec. 29, 2011

(54) DEVICE MOUNTED UNINTERRUPTABLE POWER SUPPLY SYSTEM AND METHOD

(76) Inventors: Toru Okubo, Tokyo (JP); Gidi Lederer, Haifa (IS)

(21) Appl. No.: 12/855,445

(22) Filed: Aug. 12, 2010

(30) Foreign Application Priority Data
Jun. 24, 2010 (JP) 2010-143678

(51) Int. Cl. H02J 1/10

(52) U.S. Cl. 307/23

(57) ABSTRACT

Power control system for controlling power provision to an electrical device. An uninterruptable power supply (UPS) unit is mounted upon an internal circuit board of a host electrical device, and configured to provide a power reserve the host electrical device and client electrical devices electrically connected thereto. The power control system may be usefully incorporated into an intranet access switch having Power over Ethernet enabled connections.

### CROSS-REFERENCE TO RELATED APPLICATIONS

The present application claims the benefit of Japanese Patent Application No. 2010-143678 filed on 24 Jun. 2010.

### FIELD OF THE INVENTION

Embodiments of the present invention relate to power provision to electrical devices. In particular embodiments relate to uninterruptable power supply (UPS) systems incorporated into electrical devices.

### BACKGROUND

Power to electrical devices is commonly provided via power lines connecting the devices to a power supply. For many electrical devices it is convenient to provide a plug and socket connection to an Alternating Current (AC) electrical mains outlet such that they may draw power therefrom. However, such electrical devices are then dependent upon the external power source and are therefore vulnerable to interruptions to their power supply. Interruptions may result from total power failure of the source or other power supply anomalies such as power surges, power sags, power spikes and the like.

In order to counter such power anomalies, sensitive electrical devices may be plugged into an Uninterruptable Power Supply (UPS) system. UPS systems generally draw power from the power source and can serve as a buffer and backup for delivering the power to the electrical devices plugged thereinto. Typically, the UPS has a power storage unit which is charged by the external power source and which may be switched to provide power to the connected electrical device when the external power source fails.

By the nature of its function an operating UPS device should go unnoticed by the user, allowing the seamless use of an electrical device. Therefore although UPS systems may be able to offer users of electric devices significant protection, all too often users see no added value in using a UPS and are not aware of the dangers associated with power anomalies until it is too late.

Because the importance of the UPS is not apparent, many non expert users opt not to use a UPS for various reasons such as in order to reduce costs or to reduce the number of unsightly trailing wires. Furthermore, non-experts do not typically know which devices should be connected to a UPS and which may be safely connected directly to the power supply.

There is therefore a need for a convenient uninterruptable power supply which may be readily used by a non-expert. Embodiments described herein address this need.

### SUMMARY OF THE EMBODIMENTS

A power control system is herein disclosed for controlling power provision. The power control system comprises at least one uninterruptable power supply (UPS) unit mounted upon an internal circuit board of a host electrical device, and configured to provide a power reserve for at least one of the group comprising the host electrical device and at least one client electrical device electrically connected to the UPS unit.

Optionally, the UPS may comprise at least one power storage unit and at least one charger unit. Where applicable, the UPS may further comprise at least one inverter. The power storage unit may be selected from a group consisting of: electrochemical cells, capacitors, fuel-cells and flywheels. Optionally the power storage unit is replaceable. Typically, the charger unit comprises at least one rectifier.

The host electrical device may be configured to draw power from an external power supply. Optionally, the circuit board may comprise a printed circuit board (PCB). Variously, the client electrical device may be selected from at least one of a group consisting of: computers, scanners, printers, servers, network hubs, IP telephones, wireless LAN access points, cameras, Ethernet access switches, thin clients, audio output devices, visual display units and the like.

Optionally, the host electrical device may further comprise a central processing unit. Such a central processing unit may be configured to manage power provision to a plurality of the client electrical devices. In some cases, the host electrical device further comprises at least one power over Ethernet (PoE) controller; and at least one PoE port. Accordingly, the power control system may be configured to control the power provision to a network comprising a plurality of the client electrical devices, wherein the plurality of client electrical devices are connected to the host electrical device via the PoE ports. Usefully, the system may be configured to provide power to the host electrical device or one of the client electrical devices upon power failure to at least one of the devices.

Furthermore a method is taught for controlling power provision to a network comprising a host electrical device. The method comprises: mounting an uninterruptable power supply (UPS) unit upon an internal circuit board of the host electrical device, the UPS comprising at least one power storage unit; electrically connecting the UPS unit to the host electrical device; and providing a central processing unit (CPU), the CPU managing power delivery from the power storage unit to the host electrical device. Optionally, the network may comprise client electrical devices electrically connected to the UPS unit, and the CPU managing power delivery to a plurality of the client electrical devices.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments of the present invention only, and are presented in the cause of providing what is believed to be the most useful and readily understood description of the principles and conceptual aspects of embodiments of the invention. In this regard, no attempt is made to show structural details in more detail than is necessary for a fundamental understanding of the embodiments; the description taken with the drawings making apparent to those skilled in the art how the several fowls of the invention may be embodied in practice. In the accompanying drawings:

FIG. 1 is a block diagram showing the main components of an embodiment of a power control system including a device mounted uninterruptable power supply (UPS);

FIG. 2 is a block diagram showing an embodiment of the UPS unit which may be used in the power control system of FIG. 1;

FIG. 3a is a block diagram of an embodiment of the power control system in which a DC UPS unit is incorporated into an electric device;

FIG. 3b is a block diagram of an exemplary embodiment of the power control system in which a DC UPS unit is integrated with an Ethernet access switch;

FIGS. 4a and 4b are exploded isometric views of another embodiment of the power control system integrated with an Ethernet access switch;

FIG. 5 is a schematic exploded isometric view of battery pack chassis for use in the power control system of FIGS. 4a and 4b; and

FIG. 6 is a flowchart representing the main steps of a method for power provision using a device mounted UPS system.

### DESCRIPTION OF SELECTED EMBODIMENTS

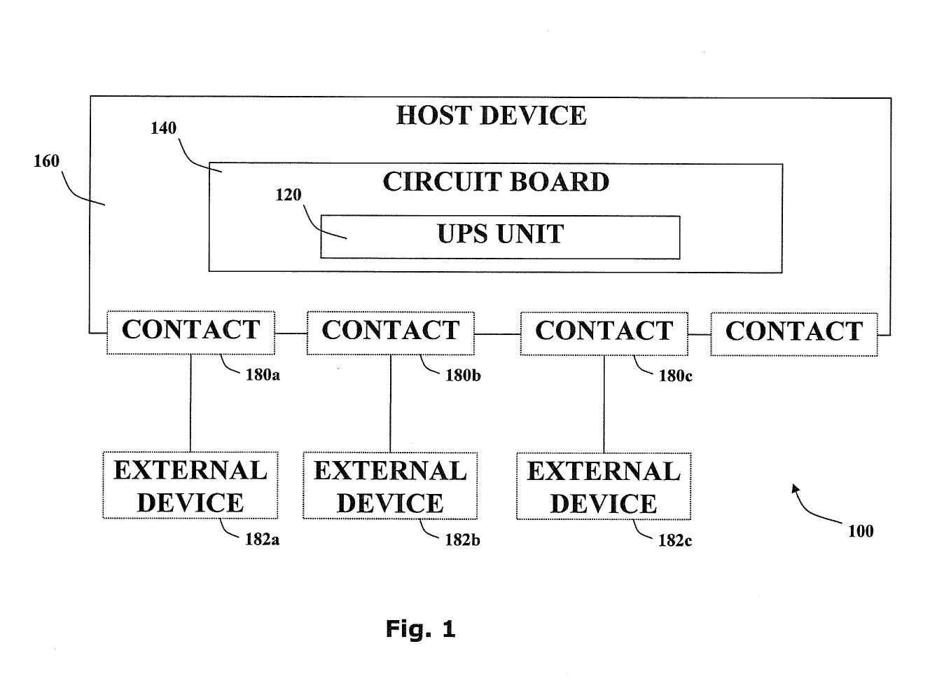

Reference is now made to FIG. 1 showing the main components of a first embodiment of a power control system 100. The power control system 100 includes an uninterruptable power supply (UPS) unit 120 mounted upon an internal circuit board 140 of a host electrical device 160.

The UPS unit 120 is configured to provide a power reserve for the host electrical device 160 in the event of power failure or other interruption to the power supply. Optionally, connectors 180 may be provided via which additional client electrical devices 182 may be connected. Accordingly, the UPS unit may be further configured to provide a power reserve to the external client devices 182 connected thereto.

According to various embodiments, a variety of electrical devices may host the UPS unit 120 such as computers, scanners, printers, servers, network hubs/switches, IP telephones, wireless LAN access points, cameras, Ethernet switches, thin clients, audio output devices, visual display units or the like.

For example where the host 160 is a computer, the UPS may be mounted upon its motherboard or other internal printed circuit board unit. External client devices 182 may then be connected via Universal Serial Bus (USB) power ports, Power over Ethernet (PoE) ports or other power connectors 180.

It is further noted that one or more of the external client devices 180 may additionally house their own UPS units (not shown) which may be configured to share their power reserves reciprocally with the host device 160.

It will be appreciated that in contradistinction to prior art UPS systems, the power control system 100 of the first embodiment is integral to the host device 160, thereby obviating the requirement for an external UPS connection. Accordingly, power protection is provided for the host device 160 with no specialist knowledge required from the user. Furthermore, the lack of an external UPS unit may serve to reduce the number of trailing wires necessary to connect the electrical device, and reduce the size, weight and cost of the uninterrupted host device.

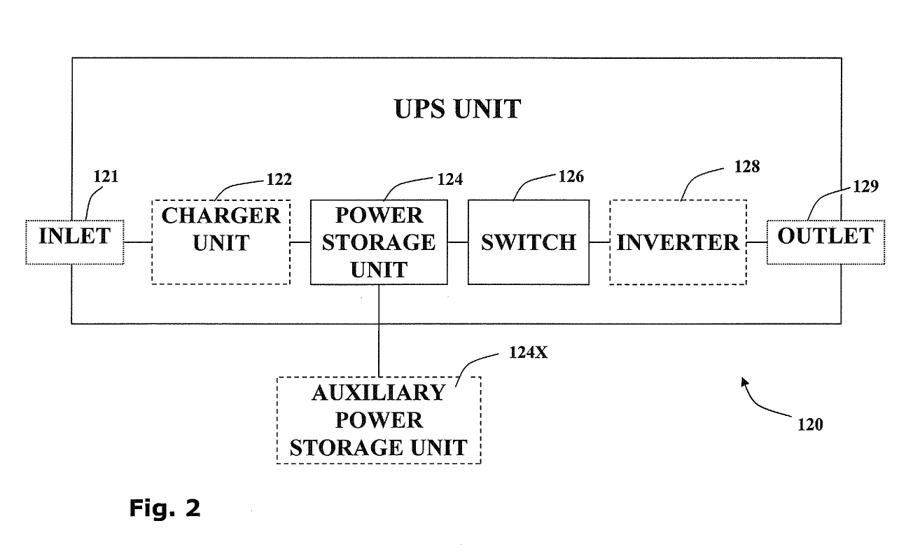

Referring now to the block diagram of FIG. 2, the main components of one possible embodiment of the UPS unit 120 is shown which may be incorporated into the power control system 100 of FIG. 1. The UPS unit 120 includes a power inlet 121, a power storage unit 124, a switch 126 and a power outlet 129.

When no power interruption is detected at the inlet 121, the UPS is configured to store power in the power storage unit 124. When incoming power drops below a determined threshold value, the switch 126 is configured to draw power from the power storage unit 124 to the power outlet 129. The host device may then draw power from the UPS power outlet 129.

Optionally, where the host device requires AC power an inverter 128 may be provided such that the typically DC output of a power storage unit may be converted to AC before being provided to the host device via the outlet 129.

Various power storage units 124 may be used according to various embodiments, such as electrochemical cells, capacitors, fuel-cells and the like. Where the power drawn by the inlet 121 is alternating current and the power storage unit 124 requires direct current, a charging unit 122 may be provided including a rectifier, power regulator and other charging circuitry necessary to charge the power storage unit 124.

Optionally, an auxiliary power storage unit 124X may be provided externally in order to provide a larger power capacity. Auxiliary power storage 124X may be a replaceable power pack accessible from the host device 160. Alternatively, where large power storage is required, a flywheel, fuel cell or the like may be used to store large quantities of power.

Although only a Standby Power Supply (SPS) type UPS is described above. Other types of UPS may be preferred as suit requirements such as line-interactive, double-conversion, online, offline, hybrid, ferro-resonant UPS systems or the like.

It is noted that the embodiments described above may be adapted to providing either AC or DC power internally in the case of power interruptions. Other embodiments are configured to provide power to the host device solely in the case of power failure, i.e. a total loss of input voltage to the device. Still other embodiments may be adapted to providing only DC power as described below.

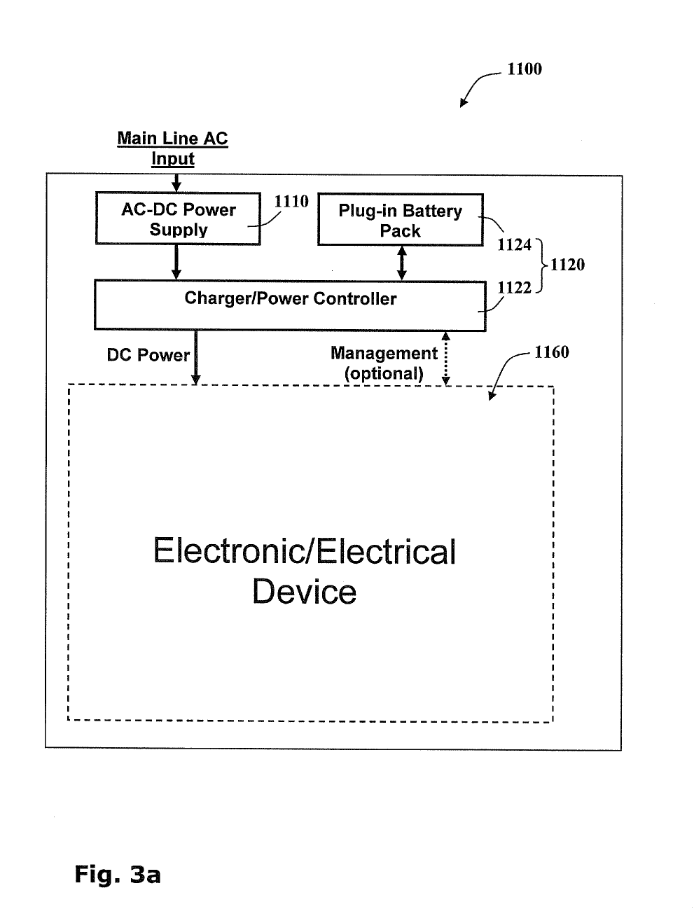

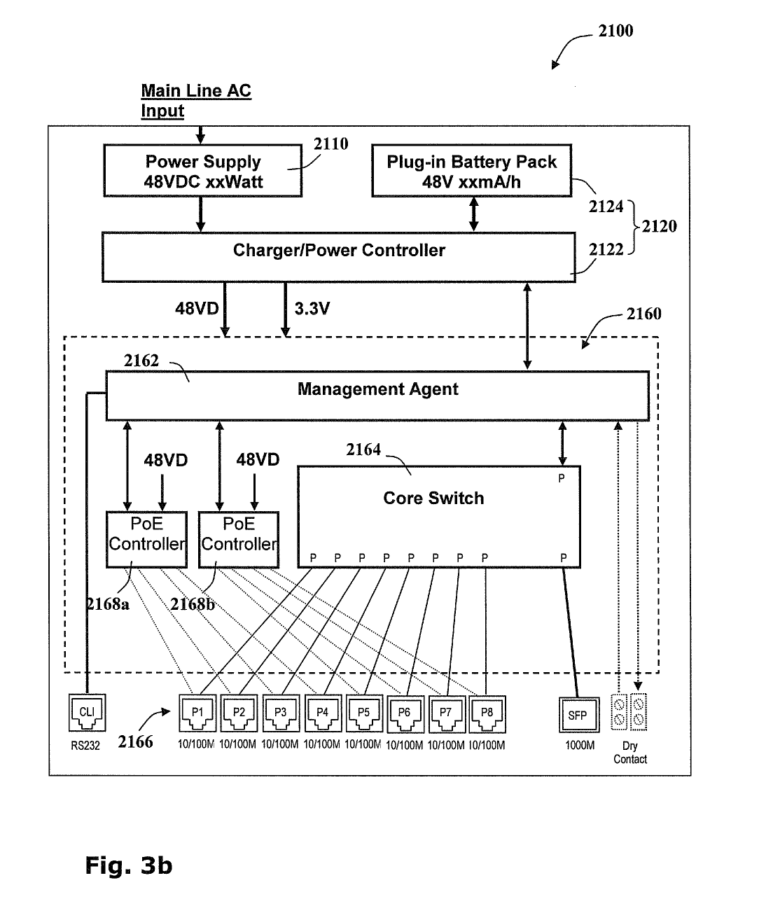

Reference is now made to the block diagram of FIG. 3a representing an embodiment of the power control system 1100 in which a DC UPS unit 1120 is integrated together with an electric device 1160.

It is a particular feature of the embodiment of the power control system 1100, that the DC power supply 1110, which is configured to convert an AC main line voltage to DC voltage, is connected to the electric device 1160 via the onboard DC UPS unit 1120.

The DC UPS unit 1120 includes a charger/power controller unit 1122 and a power storage unit 1124, for example a battery pack. The charger/power controller unit 1122 is configured to monitor the power supply 1110 and to selectively charge the power storage unit 1124 or to draw power from the power storage unit 1124 depending upon the reliability of the power supply.

The power storage unit 1124, which may be a replaceable unit, is configured to provide continuous power to the electrical device 1160 in the case of power interruptions which in some embodiments include only total loss of input voltage and in other embodiments include other types of interruptions such as voltage spikes.

When no power interruption is detected at the power supply 1110, the power controller 1122 is configured to store power from the main line AC in the power storage unit 1124 and to provide power to the electrical device 1160. When incoming power drops below a determined threshold value, the power controller 1122 may be activated to stop charging the power storage unit 1124 and instead to provide power from the power storage unit 1124 to the electrical device 1160.

Various power storage units 1124 may be used according to various embodiments, such as electrochemical cells, capacitors, fuel-cells and the like. The power controller 1122 may include a rectifier, power regulator and other charging circuitry to charge the power storage unit 1124. Furthermore the power controller 1122 may be additionally configured to monitor and manage power provision to the electrical device 1160 as described in greater detail in relation to FIG. 3b below.

Optionally, an auxiliary power storage unit (not shown in FIG. 3a) may be provided externally in order to provide a larger power capacity. The auxiliary power storage may be a replaceable power pack accessible from the host device 1160. Alternatively, where large power storage is required, a flywheel, fuel cell or the like may be used to store large quantities of power.

Although only a Standby Power Supply (SPS) type UPS is described above. Other types of UPS may be preferred as suit requirements such as line-interactive, double-conversion, online, offline, hybrid, ferro-resonant UPS systems or the like.

Reference is now made to the block diagram of FIG. 3b representing an exemplary embodiment of a power control system 2100 including a DC power supply 2110, an onboard DC UPS unit 2120, and an Ethernet access switch unit 2160.

The Ethernet access switch unit 2160 is one example of a switching hub for connecting segments of a network, workstations, IP phones, wireless access points etc. with or without PoE. The Ethernet access switch 2160 of the example includes a management agent 2162, a core switch 2164 and an outlet array 2166 including eight Ethernet ports 2166 P1-8 and at least one uplink port SFP.

The management agent 2162 is typically a microprocessor, for example a Freescale MCP875 unit, configured to support various communication protocols such as Web, Telnet, SNMP V2, HTTPS or the like. The management agent 2162 may provide setup, configuration and monitoring of the access switch functionalities such as RSTP/STP, MAC security, IGMP snooping, port mirroring, upload/download configuration, 802.1x or the like.

In addition the management agent 2162 may further control power provision to client devices connected to the access switch 2160 via Ethernet ports P1-8. Accordingly the management agent may be in communication with PoE controllers 2168a, 2168b.

The core switch 2164, such as a Marvell 88E6095F unit or the like, is configured to selectively connect the management agent to the ports P1-8, SFP, thereby providing data communication between the electrical devices connected thereto.

It is a particular feature of the exemplary embodiments of the power control system 2100, that the DC power supply 2110 (capable of converting AC main line voltage to DC voltage) is configured to connect to the management agent 2160 via the onboard UPS unit 2120.

It is noted that the power storage unit 2124 of the exemplary embodiment 2100 may include a plug-in rechargeable 48V 1100 mA/h battery pack or the like, providing full power backup support to the Ethernet access switch 2160, including the PoE capability described below, for at least forty-five minutes or so.

It is a further feature that the Ethernet ports P1-8 of the exemplary embodiment 2100 may be further connected to at least one Power over Ethernet controller 2168a, 2168b. Power over Ethernet is a system for passing electrical power, along with data, on Ethernet cabling. This may be used to provide power to external client electrical devices connected to the Ethernet access switch unit 2160 via the Ethernet ports P1-8. Accordingly the Ethernet ports P1-8 may be 10/100Base-T copper ports with 802.3af PoE/PSE support up-to full class0/Class3 for example, providing up to 15.4 watts of power to each connected client device. Alternatively, where appropriate IEEE 802.3af PoE enabled ports may be preferred which may allow up to 15.4 watts of power to be provided. Still other power provision standards may occur to the practitioner.

Thus the exemplary embodiment 2100 of the power control system is able to manage power provision and to provide UPS support to a number of electrical devices connected to the central Ethernet access switch 2160 via the PoE ports 2166. It will be appreciated that such a centralized system may be more convenient and intuitive for use particularly by a non-expert user.

According to various embodiments, a number of electrical devices having internal UPS systems are interconnected into a single network thereby providing a high degree of power redundancy allowing connected device to reciprocally provide power to the network in case of power irregularities. It is further noted that a data connection such as the Ethernet link between electrical devices connected to the access switch 2160 may be used to centrally manage power control over the whole of such a network.

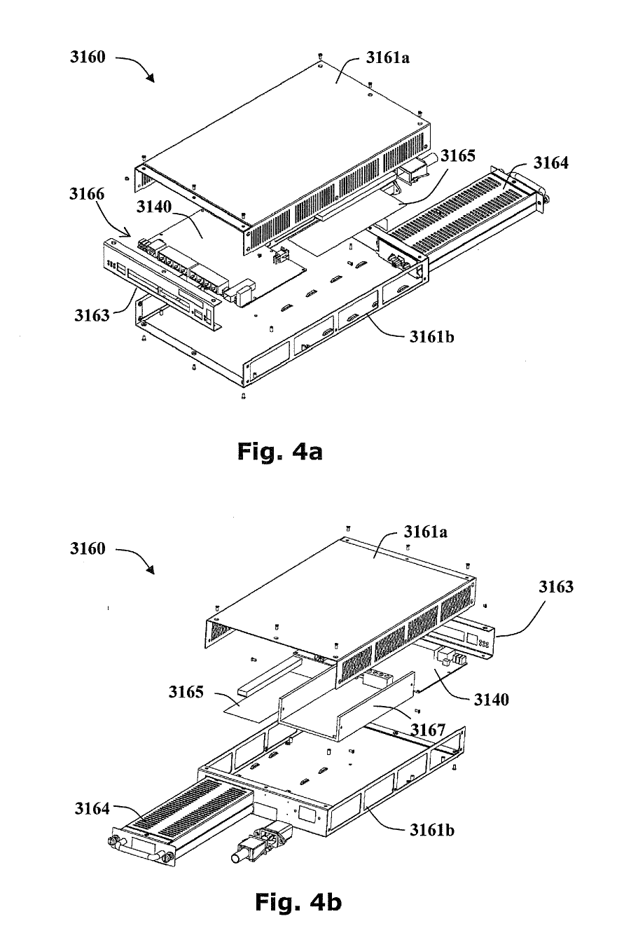

Referring now to FIGS. 4a and 4b, schematic exploded isometric views are presented to better illustrate how an embodiment of the power control system may be incorporated into an Ethernet access switch 3160. The Ethernet access switch 3160 includes a housing cover 3161a, a housing base 3161b, a front panel 3163, a slide foil 3165, an internal chassis 3167, a removable power pack 3164, a printed circuit board 3140 and an outlet array 3166.

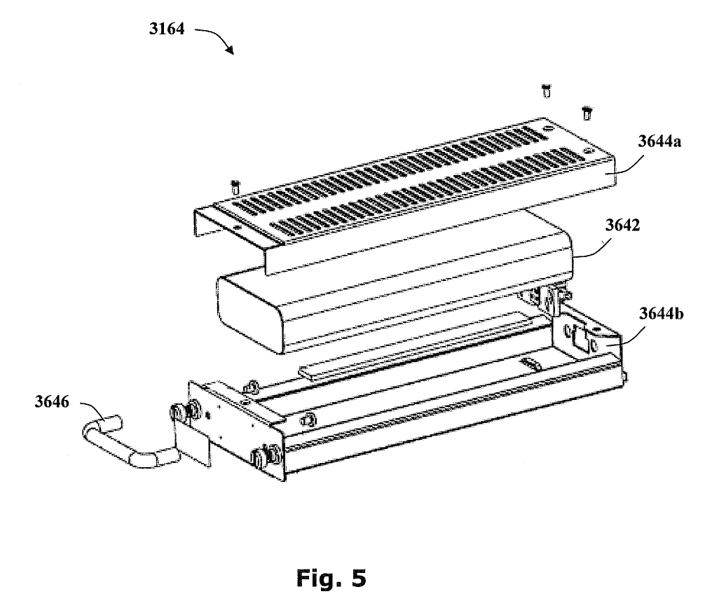

With reference to FIG. 5 a schematic exploded isometric view is presented of a removable power pack unit 3164 for use in the power control system of FIGS. 4a and 4b. The removable power pack unit 3164 includes a chargeable battery 3642 housed in a casing 3644 having a base 3644a and a cover 644b. A handle 646 is provided upon the casing base 3644b. The casing 3644 is configured to slide into and out of the housing base 3161b for maintenance and replacement of the battery 3642.

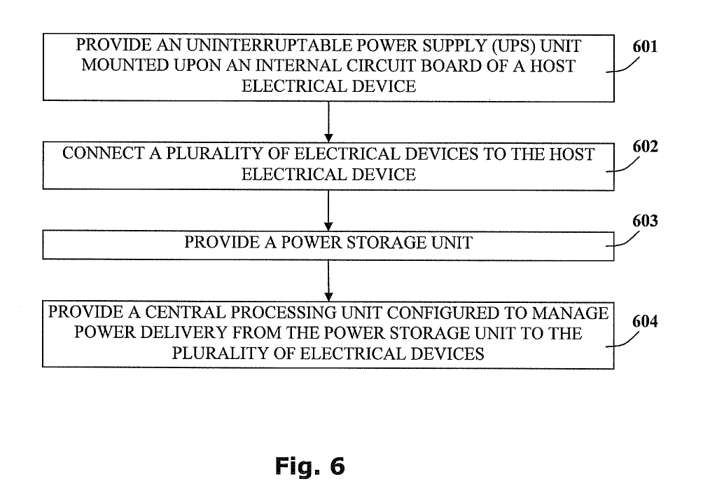

Referring now to the flowchart of FIG. 6, the main steps are indicated of a method for power provision to a network of electrical devices using a device mounted UPS system. The method includes the steps of: providing an uninterruptable power supply (UPS) unit mounted upon an internal circuit board of a host electrical device 601; connecting a plurality of client electrical devices to the host electrical device 602; providing a power storage unit 603; and providing a central processing unit configured to manage power delivery from the power storage unit to the plurality of client electrical devices 604 and to the host electrical device.

The examples described above present various selected embodiments of device mounted uninterruptable power supply systems and methods. It is noted that further embodiments are anticipated which also fall within the scope of the present invention. The scope of the present invention is defined by the claims and includes both combinations and sub combinations of the various features described hereinabove as well as variations and modifications thereof, which would occur to persons skilled in the art upon reading the foregoing description.

In the claims, the word “comprise”; and variations thereof such as “comprises”, “comprising” and the like indicate that the components listed are included, but not generally to the exclusion of other components.

What we claim is:

1. A power control system for controlling power provision, said power control system comprising :
at least one uninterruptable power supply (UPS) unit mounted upon an internal circuit board of a host electrical device and configured to provide a power reserve for at least one of the group comprising the host electrical device; and
at least one client electrical device electrically connected to the UPS unit.

2. The power control system of claim 1 wherein said UPS comprises at least one power storage unit and at least one charger unit.

3. The power control system of claim 2 wherein said UPS further comprises at least one inverter.

4. The power control system of claim 2 wherein said power storage unit is selected from a group consisting of: electrochemical cells, capacitors, fuel-cells and flywheels.

5. The power control system of claim 2 wherein said power storage unit is replaceable.

6. The power control system of claim 2 wherein said charger unit comprises at least one rectifier.

7. The power control system of claim 1 wherein said host electrical device is configured to draw power from an external power supply.

8. The power control system of claim 1 wherein said circuit board comprises a printed circuit board (PCB).

9. The power control system of claim 1 wherein said client electrical device is selected from at least one of a group consisting of: computers, scanners, printers, servers, network hubs, IP telephones, wireless LAN access points, cameras, Ethernet access switches, thin clients, audio output devices and visual display units.

10. The power control system of claim 1 wherein said host electrical device further comprises a central processing unit.

11. The power control system of claim 10 wherein said central processing unit is configured to manage power provision to a plurality of said client electrical devices.

12. The power control system of claim 1 wherein said host electrical device further comprises at least one power over Ethernet (PoE) controller; and at least one PoE port.

13. The power control system of claim 12 configured to control the power provision to a network comprising a plurality of said client electrical devices, wherein said plurality of client electrical devices are connected to said host electrical device via said PoE ports.

14. The power control system of claim 1 wherein the system is configured to provide power to the host electrical device or one of the client electrical devices upon power failure to at least one of said devices.

15. A method for controlling power provision to a network comprising a host electrical device, said method comprising:
mounting an uninterruptable power supply (UPS) unit upon an internal circuit board of the host electrical device, said UPS comprising at least one power storage unit;
electrically connecting said UPS unit to said host electrical device; and
providing a central processing unit (CPU), the CPU managing power delivery from said power storage unit to said host electrical device.

16. The method of claim 15, the network further comprising client electrical devices electrically connected to said UPS unit, and the CPU managing power delivery to a plurality of said client electrical devices.
